(19) United States
(12) Patent Application Publication
(10) Pub. No.: US 2004/0001082 A1
(43) Pub. Date: Jan. 1, 2004

(54) System and method of interaction with a computer controlled image display system using a projected light source

(76) Inventor: Amir Said, Cupertino, CA (US)

Correspondence Address: HEWLETT-PACKARD COMPANY, Intellectual Property Administration, P.O.Box 272400, Fort Collins, CO, 80527-2400, US

(21) Appl. No.: 10/180,606

(22) Filed: Jun. 26, 2002

(51) Int. Cl. G09G 5/00

(52) U.S. Cl. 345/730

(57) ABSTRACT

A display system and method are described in which information encoded within a light signal directed at a computer controlled display is used to interact with the display system. The information encoded light signal and displayed images are captured by an image capture device and the encoded information is extracted from the captured image data. The extracted information is provided to the display system to allow a user to interact with the computer controlled display system using the light projection device.

### FIELD OF THE INVENTION

The present invention relates to a system and method of interacting with a projected image display, and in particular, this disclosure provides a system and method of interacting with a projected image display using a projected light source.

### BACKGROUND OF THE INVENTION

Displayed images (e.g., slides) projected onto a display screen or display area are often used during an oral presentation. The displayed images serve to enhance or supplement the oral portion of the presentation. Often the image data for driving a display device for displaying the images is provided by a computer system. Commonly, specific software applications that are run by the computer system (e.g., slide generation software application) to generate the image data to be displayed by the display device.

FIG. 1 shows an example of a prior art computer controlled display system including a computer system 10 for providing image data 10A for driving a display device 11 to project an image (referenced by dashed lines 11A and 11B) on a display area 12.

In this type of system, a presenter commonly uses a pointing device such as a light or laser pointer 15 to point to the displayed image in order to bring the audiences attention to a certain location within the displayed image. In addition to the laser pointer 15, the presenter often uses an input device 14 (e.g., a mouse, keyboard, etc.) to control the computer system and software application generating the image data 10A. Commonly the input device is a remote mouse that transmits control signals via infrared optical signals. The problem with this technique of interacting with the display system is that using two handheld devices (i.e., pointing device and input device) can become confusing and burdensome while giving a presentation. In addition, the presenter must have a clear optical path to be able to interact with the computer system with the remote input device, thereby limiting the presenter's ability to move around while giving the presentation or requiring them to re-establish an optical path with the computer system.

What would be desirable is a simplified technique of interacting with a computer controlled display system that does not require multiple input devices.

### SUMMARY OF THE INVENTION

A display system including a computer system for controlling and generating image data for displaying an image is described. The display system further includes a device for projecting a light signal at the displayed image where the light signal is characterized in that it includes encoded information. An image capture device captures image data that includes the displayed image and the projected light signal. An image analyzer detects and extracts the encoded information within the captured image data such that the extracted information can be provided to the display system thereby allowing a user to interact with the display system using the pointing device.

A method for use in a display system including a computer system for generating image data for displaying an image is described including projecting a light signal at the displayed image. The light signal is characterized in that it includes encoded information. Image data is captured where the image data includes the displayed image and the projected light signal. The image data is analyzed to extract the encoded information. The extracted information is then provided to the display system.

### BRIEF DESCRIPTION OF THE DRAWINGS

FIG. 1 shows a prior art system for interacting with a computer controlled image display system using a prior art projected light source and an input device;

FIG. 2A shows a first embodiment of a system for interacting with a computer controlled image display system using a projected light source in accordance with the present invention;

FIG. 2B shows a functional flowchart of one exemplary embodiment of the image analyzer in accordance with the present invention;

FIG. 3 shows a second embodiment of a system for interacting with a computer controlled image display system using a projected light source in accordance with the present invention.

FIG. 4 shows an embodiment of a method for interacting with a computer controlled image display system using a projected light source in accordance with the present invention;

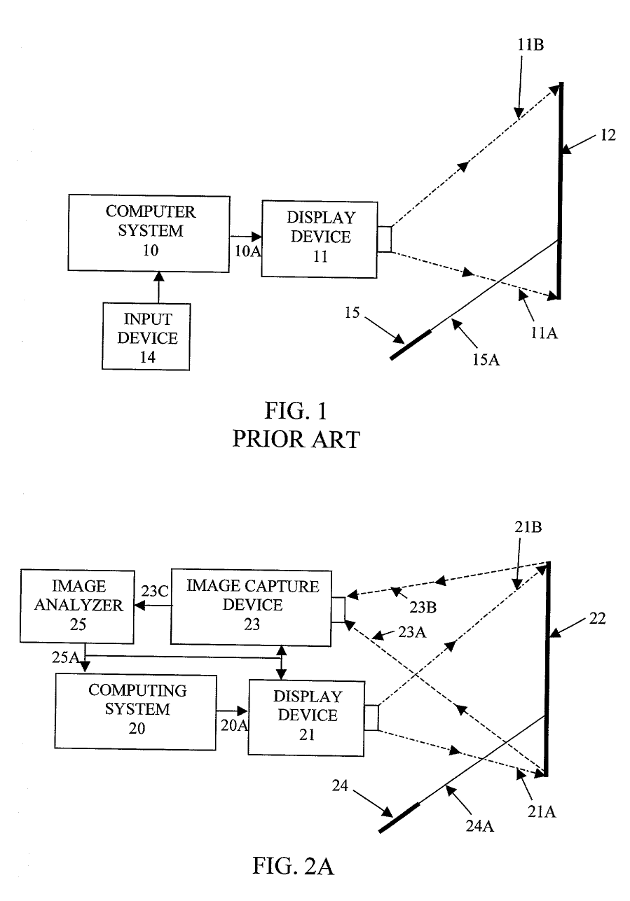

### DETAILED DESCRIPTION OF THE INVENTION

The system and method of the present invention provides a simplified technique in which a presenter giving an oral presentation can provide information or control to the computer controlled display system using a light projection device. Moreover, the system and method provides a superior alternative to the traditional practice of using multiple conventional input devices when interacting with the computer controlled display system. It should be noted that for purposes of the subject disclosure a computer controlled display system includes at least a computer, processing system or device, or a computing system or device for generating and controlling the display of image data, a display area for displaying the images, and a means for displaying the image data in the display area controlled by the computer, processing system or device, or computing system or device.

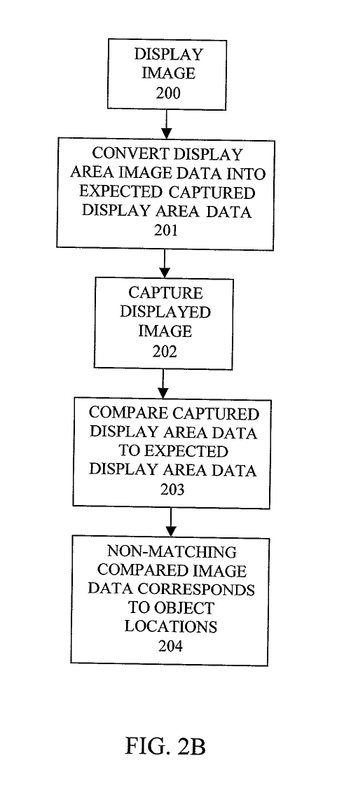

FIG. 2A shows a first embodiment of the system of the present invention including a computer system 20 for providing image data 20A for displaying on the display area 22. In one embodiment, the computer system includes at least a storage area (not shown) for storing image data. In another embodiment (not shown), the computer system includes a software application, such as slide presentation generation software, for generating image data 20A. The image data 20A drives the display device 21 to display an image (indicated by dashed lines 21A and 21B) onto display area 22. The display area may be a display screen or may simply be a wall.

A device 24 projects a light signal 24A at the displayed image on display area 22. In one embodiment, the device 24 is a pointing device used during a slide presentation by a presenter to identify locations of importance on the display area. In another embodiment, the pointing device is a laser pointer. The light signal 24A is characterized in that it has associated encoded information. Information can be encoded into the light signal in any manner which causes changes to the signal that are detectable by an image capture device. In one embodiment, information is encoded within the light signal by changing one or any combination of color, light pulse frequency, or light pulse length. In one embodiment, changes to the signal can be achieved by one or more control options (e.g., buttons, dials, rollers, etc.) on device 24. Activation can occur by, for example, depressing buttons, turning dials, or rotating rollers. For instance, by activating a first control option (e.g., depressing a first button), a first encoded signal is emitted from device 24 and by activating a second control option (depressing a second button), a second encoded signal is emitted. Activation of a combination of control options (e.g., depressing both first and second buttons) may cause the device to emit a third encoded signal. Still another control option may simply cause device 24 to emit a signal having no encoded information that is used for the purpose of emitting just a pointing signal.

An image capture device 23 captures an image (indicated by dashed lines 23A and 23B) including the displayed image (21A-21B) and the light signal 24A projected onto the displayed image. It should be noted that the image capture device can be either an analog or digital image capture device and can be either a still image capture device or a video device. Image capture device 23 is characterized such that it has a high enough resolution to detect and capture changes associated with encoded information in light signal 24A. The captured image data 23C is coupled to image analyzer 25 that detects and extracts the light signal 24A image data from the captured image data 23C. It should be noted that the image analyzer can be implemented by one of hardware, software, or firmware.

Once the light signal image data is extracted from the captured image data 23C, it is analyzed to identify the information encoded within the light signal 24A. A signal 25A corresponding to the extracted information can then be provided to the remainder of the display system including at least computer system 20, display device 21, and/or image capture device 23. In one embodiment, signal 25A is provided to the computer system to control, for instance, the operating system or applications running on the computer system. For instance, the information can be used to cause the application software generating the slide images to switch to a new slide. In general the information can correspond to any input signal that the computer system might expect to receive from a conventional input device such as a keyboard or a mouse. In another embodiment, signal 25A can be provided to the display device to cause it to adjust its settings. In still another embodiment, signal 25A can be provided to the image capture device for controlling the parameters (e.g., resolution) of capturing image data. It should be noted that in one embodiment the encoded information obtained from the extracted image data is decoded within the image analyzer 25. In another embodiment encoded information is provided to the elements of the display system and is decoded within each of these elements.

An exemplary implementation of image analyzer 25 is described in U.S. application Ser. No. 09/775,032 filed Jan. 31, 2001 (attorney docket no.: 100110204) entitled “A System and Method for Robust Foreground and Background Image Data Separation for Location of Objects in Front of a Controllable Display within a Camera View” and assigned to the assignee of the subject application. In this case, detection and extraction is performed by separating image data corresponding to objects located on or in front of the display area 22, (e.g., a presenter and/or a pointer from image data corresponding to the displayed images). FIG. 2B shows an exemplary functional flowchart of how the image analyzer 25 can detect and extract image data corresponding to the light signal. According to this example, the image data is displayed (block 200) by a computer controlled display system. This image data corresponds to the image data 20A provided by the computer system 20 (FIG. 2A). The image data 20A is then converted into expected captured display area data (block 201) using previously determined transforms defined between the display area and the capture area of the image capture device. The displayed image is captured (block 202) and the expected captured display area data is then compared to actual captured data (block 203). Any non-matching data is identified as objects (i.e., laser points) (block 204).

A second exemplary implementation of image analyzer 25 is described in U.S. application Ser. No. ______ (attorney docket no.: 10017785) entitled “System and Method of Locating a Projected Laser Point on a Computer Controlled Display” and assigned to the assignee of the subject application. In this case, detection/extraction occurs by controlling the computer system to reduce the overall intensity of all pixels in the displayed image data while simultaneously detecting the laser pointer so as to make intensity of the laser point within the captured image data exceed a known maximum displayed image intensity threshold. Any pixels within the captured data identified as exceeding that threshold correspond to the location of a laser point.

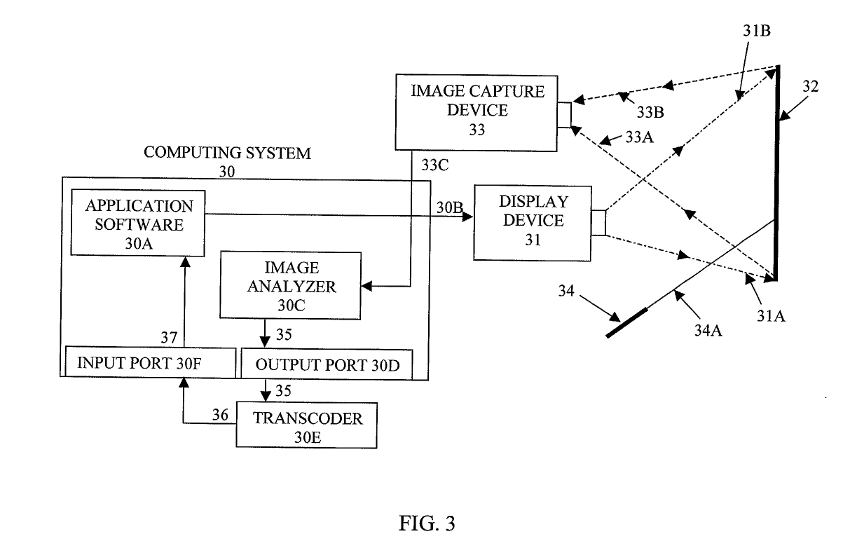

FIG. 3 shows a second embodiment of the system of the present invention in which a transcoder is used so as to provide information to the computer system 30 through the computer system's pre-existing input ports. In accordance with this embodiment, the application software 30A running within computer system 30 generates image data 30B for driving a display device 31 for displaying images (31A-31B) on a display area 32. A device 34 projects a light signal 34A onto the displayed image (31A-31B). The displayed image and the light signal are captured by image capture device 33 and captured image data 33C is coupled to image analyzer 30C. It should be noted that although analyzer 30C is shown within the computer system 30, it can be embodied separately from it. Image analyzer 30C detects and extracts image data corresponding to the light signal 34A from the captured image data 33C. In addition, image analyzer 30C analyzes the extracted image data to identify the information encoded within the light signal 34A. An information signal 35 corresponding to the extracted information is coupled to the pre-existing output port 30D of the computer system 30 which is, in turn, is coupled to a transcoder 30E. The transcoder 30E converts information signal 35 into a signal 36 adapted to the computer system's pre-existing input port 30F. In one embodiment, input port 30F is a conventional USB serial port. In particular, signal 35 is converted into a format known by input port 30F. Input port 30F then transmits a signal 37 to the application software 30A. The advantage of this system is that since the information signal 37 is converted into an already known input format by transcoder 30E and is received along a conventional and pre-existing input path (i.e., through input port 30F), the impact on the computer system of providing the information from light signal 34A to the application software 30A is minimized.

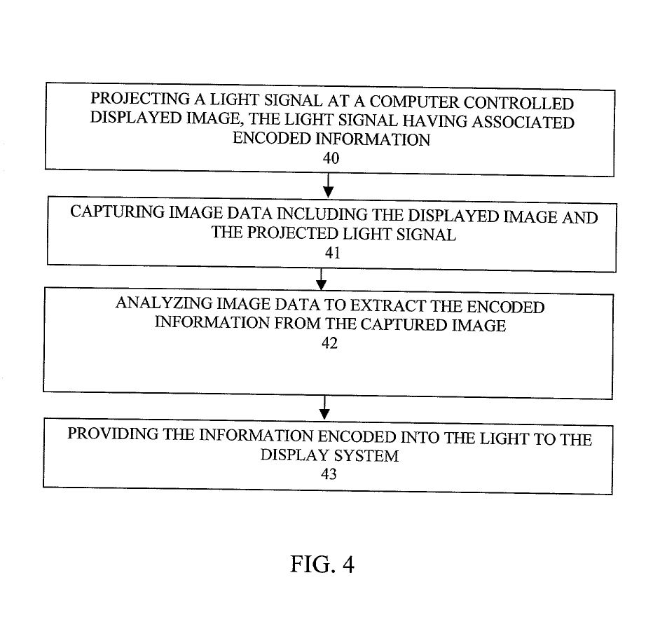

FIG. 4 shows one embodiment of a method of interacting with a display system in accordance with the present invention. The method includes projecting a light signal at a computer controlled displayed image such that the light signal has associated encoded information (40). Next, the method includes capturing image data such that the image data includes the displayed image and the projected light signal (41). It should be noted that the captured image data may include objects other than the displayed image and the projected light signal. The method further includes analyzing image data to extract the encoded information from the captured image data (42). Finally, the method includes providing the extracted information to the display system (43). In one embodiment (not shown), the method can further include extracting image data corresponding to the light signal from the captured image data and then analyzing the extracted image data to determined the encoded information. In another embodiment (not shown), the method further includes providing the extracted information in the light signal to control the computer system.

Hence, a display system and method are described in which information encoded within a light signal directed at a computer controlled display is used to interact with the display system. The system and method provides an alternate manner of interaction than traditional input devices such as a keyboard and a mouse thereby making interaction with the display system easier for a user during a presentation including the displayed image.

In the preceding description, numerous specific details are set forth in order to provide a thorough understanding of the present invention. It will be apparent, however, to one skilled in the art that these specific details need not be employed to practice the present invention. In addition, it is to be understood that the particular embodiments shown and described by way of illustration is in no way intended to be considered limiting. Reference to the details of these embodiments is not intended to limit the scope of the claims.

I claim:

1. A display system including a computer system for controlling and generating image data for displaying an image, the display system comprising:
device for projecting a light signal at the displayed image, the light signal having associated encoded information;
device for capturing image data including the displayed image and the projected light signal;
image analyzer for extracting the encoded information within the captured image data wherein the extracted information is provided to the display system.

2. The system as described in claim 1 wherein the computer system further comprises a software application for generating the image data for displaying and the extracted information is for controlling the software application.

3. The system as described in claim 1 wherein the encoded information is control information for controlling any software application being run by the computer System.

4. The system as described in claim 1 wherein the encoded information is encoded into the light signal by changing at least one optical characteristic of the light signal detectable by the image capture device.

5. The system as described in claim 1 wherein the encoded information is encoded into the light signal by changing its color.

6. The system as described in claim 1 wherein the encoded information is encoded into the light signal by changing its pulse frequency.

7. The system as described in claim 1 wherein the encoded information is encoded into the light signal by changing its pulse length.

8. The system as described in claim 1 wherein the encoded information is encoded into the light signal by simultaneously changing combinations of more than one optical characteristic of the light signal.

9. The system as described in claim 1 wherein the device for projecting a light signal is a laser pointer.

10. The system as described in claim 1 wherein the image capture device is one of a video and still camera and one of an analog and digital camera.

11. The system as described in claim 1 wherein the image analyzer is implemented by one of hardware, software, and firmware.

12. The system as described in claim 1 further comprising a transcoder for converting the extracted information into a pre-existing input signal format and coupling the converted signal to the pre-existing computer system input port whereby the extracted information is provided to the computer system through a pre-existing computer system signal path.

13. A method for use in a display system including a computer system for generating image data for displaying an image, the method comprising:
projecting a light signal at the displayed image, the light signal having associated encoded information;
capturing image data including the displayed image and the projected light signal; analyzing the captured image data to extract the encoded information;
providing the extracted information to the display system.

14. The method as described in claim 13 further comprising encoding information in the light signal by changing the color of the light signal.

15. The method as described in claim 13 further comprising encoding information in the light signal by changing pulse frequency.

16. The method as described in claim 13 further comprising encoding information in the light signal by changing pulse length.

17. The method as described in claim 13 further comprising controlling the computer system with the extracted information.

18. The method as described in claim 13 further comprising controlling application software within the computer system with the extracted information to control the displayed image data.

19. The method as described in claim 13 wherein analyzing captured image data to extract the encoded information comprises:
extracting image data corresponding to the light signal from the captured image data; and
analyzing the extracted image data to obtain the information encoded in the light signal.
